(19) United States
(12) Patent Application Publication
(10) Pub. No.: US 2024/0209964 A1
(43) Pub. Date: Jun. 27, 2024

(54) CONVEYING PIPE PART OF A PNEUMATIC MATERIAL CONVEYING SYSTEM, CONVEYING PIPE ARRANGEMENT AND METHOD FOR FORMING A CONVEYING PIPE ARRANGEMENT

(71) Applicant: Maricap Oy, Vantaa (FI)

(72) Inventor: Göran SUNDHOLM, Tuusula (FI)

(73) Assignee: Maricap Oy, Vantaa (FI)

(21) Appl. No.: 18/288,873

(22) PCT Filed: May 2, 2022
(86) PCT No.: PCT/FI2022/050284

§ 371 Date: Oct. 30, 2023

(30) Foreign Application Priority Data
May 6, 2021 (FI) 20215535

(51) Int. Cl. F16L 9/147; B65G 53/04; F16L 47/03; F16L 47/06

(52) U.S. Cl. CPC F16L 9/147; B65G 53/04; F16L 47/03; F16L 47/06

(57) ABSTRACT

A conveying pipe part (20) of a pneumatic material conveying system for conveying solid materials, the conveying pipe part comprising an inner layer, i.e. a wear part (26), and an outer pipe part (25) arranged to enclose the wear part (26). The outer pipe part (25) may be pressure-retaining plastic material and the inner layer, i.e. the wear part (26), may be wear-resistant steel material.

### FIELD OF THE INVENTION

The invention relates to a conveying pipe part of pneumatic conveying systems for solid materials. The invention also relates to a conveying pipe arrangement. The invention also relates to a method for forming a conveying pipe connection.

### BACKGROUND OF THE INVENTION

In connection with pneumatic material conveying systems, metal pipes have often been used in the conveying pipework. Especially in large systems in which the material conveying distances are long, the conveying pipeworks, especially the main pipeworks, may become in length rather long, typically several kilometre long conveying pipeworks. The pipe diameters of conveying pipeworks of the known systems are rather large, of the order of 200-800 mm, whereby the costs for a pipework formed from metal pipes are rather high.

This matter of fact has been attempted to be alleviated by forming material conveying pipeworks from plastic or a plastic composite material. The pneumatic material conveying systems often convey material placing requirements on wear resistance of the pipe parts. Especially pneumatic conveying systems for solid wastes often transport materials that place their specific requirements on wear resistance of the conveying pipework. Such materials include for example glass, metal, sand and corresponding materials. Pipe parts exposed to wearing often include for example pipe elbows or various connections. It has also been observed that wearing of the plastic material at the inner surface of the pipe increases when the conveying speed rises, for example to the power of 2.65, and the temperature of the pipe rises for example due to the pressure loss and friction, such as upon contact of the conveyed material with the inner surface of the pipe, or due to external conditions.

In addition, it is often necessary to provide different radiuses of curvature for the conveying pipe. In pipe parts manufactured from plastic or plastic composite material, thermal treatment of the pipe part is required for the pipe part to remain in the bent shape. The possibilities for thermal treatment are, especially in installation conditions, very limited or even impossible. When bending the pipe, there is also a risk that the pipe folds in such a way that the size or shape of the flow orifice of the pipe will change in an undesirable manner, which especially in pneumatic conveying pipeworks intended for the transport of solid wastes may cause harm to the functionality of the system.

In conveying pipeworks formed especially from plastic pipes or plastic composite pipes, muff connections may generally be used in order to connect separate pipe parts to each other end to end. In these connections, to a muff, i.e. a sleeve part, disposed at a connection point such that the ends of the pipe parts to be connected to each other are inside the muff and the muff thus around the connection point, extending in a longitudinal direction of the pipes to a distance from the connection point in both directions. The muff part or the section of the pipe part to be connected has been provided with thermal resistances or the like, whereby electric current is supplied to the resistances when the connection is being formed, whereby the resistances are heated and a connection is formed between the muff part and the pipe parts. Such thermoplastic pipe connections have been described for example in publications U.S. Pat. Nos. 2,739,829, 4,530,521 and 4,906,313.

In the known configurations, conveying pipes may become heavy and difficultly handleable, especially when taking into consideration that solid material which may be pipe-wearing, and also material which may cause corrosion in the metal pipes may often be transported in the pneumatic material conveying systems.

The object of this invention is to provide a completely new solution for a conveying pipe arrangement of a pneumatic solid material conveying system, by means of which arrangement the problems of the prior art may be avoided. One important object is to provide a conveying pipe part and a conveying pipe arrangement suitable for pneumatic conveying pipeworks of waste transport systems. Another object is to provide, for a conveying pipework formed mainly from plastic or plastic composite material, a solution by means of which the problems of the prior art will be avoided. It is an object to provide a conveying pipe part that may be bent, even in installation conditions, to a desired shape and the connecting of which may be easily accomplished also to a plastic composite or plastic pipe. One object is to provide a pipe part that is suited in its wear resistance properties to be used in the conveying pipeworks of pneumatic conveying systems for solid waste material.

Another object is to provide a solution for connecting the pipe parts of a conveying pipework to each other, wherein the most typical connection welding methods or gluing of plastics, especially plastic pipes, may be used.

### SUMMARY OF THE INVENTION

The invention is based on an idea that a pipe part comprises a combination of a wear part, such as a steel pipe, around which for example tubular plastic material or a plastic composite layer or plastic layer has been arranged as an outer pipe part. The outer pipe part may be warmed and the wear part may be pushed into the channel of the outer pipe part. As it cools down, the outer pipe part may shrink over the wear part. The conveying pipe part may be connected to another conveying pipe part by connecting the plastic or plastic composite parts to each other directly or via a connection sleeve part, for example by a plastic welding method or by gluing.

The solution is suited in particular for pipe bends and pipe branches which are subjected to greater wearing.

According to a first aspect the invention relates to a conveying pipe part of a pneumatic material conveying system for conveying solid materials, the conveying pipe part comprising an inner layer, i.e. a wear part, and an outer pipe part arranged to enclose the wear part. The invention is characterized by the features set out in the claims.

According to one embodiment the outer pipe part may be pressure-retaining plastic material and that the inner layer, i.e. the wear part, may be wear-resistant metal material. According to one embodiment the wear part may be corrosion-resistant material. The outer pipe part may have been configured mainly to retain imperviousness of the pipe part and the inner layer, i.e. the wear part, may have been configured to receive the wearing applied to the pipe part from the inner side thereof. It can be considered an advantage, for example, that the structure of the conveying pipe part provides easy connectability, formability, suitability as a conveying pipe part for solid, wearing and corrosion-causing materials. According to one embodiment the outer pipe part alone may have been configured to be pressure-retaining. This differs essentially from the solutions in which the outer pipe has been configured to provide only protection against corrosion. Stainless or acid-resistant steel is typically corrosion-resistant and also wear-resistant, whereby it is well-suited for the wear part. It has also been discovered that when stainless steel is used as the wear part, wall thickness s of the wear part may be reduced as compared to normal steel, because so-called corrosion allowance does not have to be considered in the wall thickness. Thereby the conveying pipe part provided with a thin wear part may be made relatively 15 light in its mass. In the wear part, there is also no need to take into consideration the pressure resistance or buckling requirement of the pipe. Stainless or acid-resistant steel may be very well suited for the wear part, because it has been observed that they withstand wearing about 40% better than normal steel. Also, the wear part does not have to be impervious, but may be e.g. a sheet metal pipe formed by calendering, which pipe may have an opening, a slot or the like. In general, the problem when bending thin-walled pipes may be a tendency for buckling during the bending. In one embodiment according to the invention, wherein a thin SS pipe (stainless steel or acid-resistant steel) is disposed within a PE pipe during the bending, such that the buckling tendency may be significantly reduced or even avoided when the plastic material pipe, such as a PE pipe, as the outer pipe supports the wear part.

As a result, its handleability may be easy. In addition, the reduced wall thickness of the wear part of the pipe part may allow the pipe part to be bent more easily. The weight and easy bendability may have major significance as the pneumatic material conveying systems require, depending on the application, typically several kilometre long pipeworks. The wear resistance has substantial significance, as for example in a pneumatic solid waste material conveying system, typically up to about 20000 kg of material may pass in a day through the pipe part.

According to one embodiment, wall thickness (s) of the wear part may be approximately 1-4 percent of an outer diameter (D1) of the conveying pipe part.

According to one embodiment, the wall thickness (s) of the wear part may be approximately 2-8 mm, most suitably approximately 3-5 mm. According to one embodiment, the outer diameter (D1) of the conveying pipe part may be approximately 250-550 mm.

According to one embodiment, the wear part may comprise metal, steel or stainless steel.

According to one embodiment, the outer pipe part may comprise or be pressure-retaining plastic material such as polyethylene (PE).

According to one embodiment, the conveying pipe part may have been formed by heating the outer pipe part and by bringing the wear part into the channel space of the heated outer pipe part, whereby the inner surface of the wall of the outer pipe part may be disposed against the outer surface of the wall of the wear part, and in a cooled state the outer pipe part may be pressed against the outer surface of the wear part.

According to one embodiment, the outer pipe part may be polyethylene (PE). According to one embodiment, the wear part may be stainless steel.

According to one embodiment, the conveying pipe part may be a pipe part comprising a straight pipe section and/or a curved pipe section.

According to one embodiment, the conveying pipe part may comprise a straight conveying pipe section in proximity to each end area and/or a curved pipe section between the straight conveying pipe sections, whereby an angle alpha (a) may be provided between the inlet and outlet direction of the curved pipe section and wherein the curved pipe section may have a bending radius (R).

According to one embodiment, the angle alpha (a) between the inlet and outlet direction of the curved pipe section may be approximately 15-90 degrees.

According to one embodiment, the bending radius (R) of the curved pipe section may be approximately 2.5D-10D. According to one embodiment, D may be the diameter of the pipe part, such as the outer diameter D1 or nominal diameter. According to one embodiment, the bending radius of the curved pipe section may be 1000-5500 mm. According to one embodiment, the outer diameter of the conveying pipe part may in this case be approximately 250-550 mm.

According to a second aspect, the invention relates to a conveying pipe arrangement of a pneumatic material conveying system, the arrangement comprising a first conveying pipe part and a second conveying pipe part. In the conveying pipe arrangement, the first and/or second conveying pipe part is a conveying pipe part according to one or more of the above-mentioned embodiments. The conveying pipe arrangement is characterized by the features set out in claim 12.

According to one embodiment, at a connection between the first conveying pipe part and/or the second conveying pipe part, a connection sleeve part may have been arranged to be used, which connection sleeve part is arranged to enclose a connection area of the first conveying pipe part and/or the second conveying pipe part disposed within the connection sleeve part.

According to one embodiment, the connection sleeve part may have been configured as a welding sleeve, comprising heating means, such as a resistance.

According to one embodiment, the first conveying pipe part and/or the second conveying pipe part is a composite-steel pipe or a composite pipe.

According to a third aspect, the invention relates to a method for forming a conveying pipe arrangement of a pneumatic material conveying system, the conveying pipe arrangement comprising at least one first conveying pipe part and one second conveying pipe part, as well as a connection sleeve part. In the method the first conveying pipe part is connected to the second conveying pipe part by inserting the ends of the pipe parts to be connected to each other into the connection sleeve part, and a thermoplastic connection is formed with the at least one first conveying pipe part and/or second conveying pipe part and the connection sleeve part.

According to one embodiment, at least one of the conveying pipe parts may be formed by arranging a plastic material pipe forming an outer pipe part over a wear part or wherein the wear part may be arranged in the channel space of the outer pipe part, first by heating the outer pipe part and by bringing the wear part into the channel space of the outer pipe part, so as to form a conveying pipe part wherein the inner surface is the inner surface of the wear part and the outer surface is the outer surface of the outer pipe part. According to one embodiment, one or more of the above-described embodiments of the conveying pipe part may be applied in the method.

Inventive embodiments are also disclosed in the description and drawings of this application. The inventive content of the application may also be defined differently from the following claims. The inventive content may also be comprised of several separate inventions, especially if the invention is considered in light of the expressed or implicit subtasks or in terms of the achieved benefits or sets of benefits. In this case, some features of the following claims may be redundant in terms of different inventive ideas. The features of different embodiments of the invention may be applied in connection with other embodiments within the scope of the basic inventive idea.

### LIST OF THE FIGURES

FIG. 1 shows one embodiment of a conveying pipe arrangement as a schematic view cut in a longitudinal plane,

FIG. 2 shows another embodiment of a conveying pipe arrangement as a schematic view cut in a longitudinal plane,

FIG. 3 shows one embodiment of a conveying pipe arrangement as a schematic and partly sectional view,

FIGS. 4a, 4b and 4c show some embodiments of a conveying pipe arrangement as a schematic view cut in a longitudinal plane,

FIG. 5 shows one embodiment of a conveying pipe part as a schematic and simplified view as seen from its end, and

FIG. 6 shows a detail of one embodiment.

### DETAILED DESCRIPTION OF THE INVENTION

In some cases the features set forth in this application may be used as such, disregarding the other features. On the other hand, the features set forth in this application may be combined, if necessary, to form different combinations.

The features presented in the following paragraphs in combination with other features may also be used separately, if necessary.

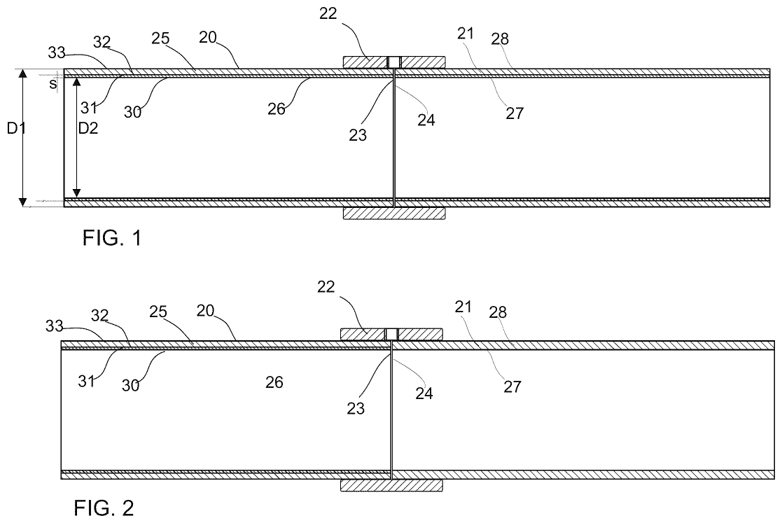

Some embodiments have been illustrated in FIGS. 1-6.

FIG. 1 shows part of a conveying pipe arrangement of a pneumatic material conveying system according to one embodiment as a partly sectional view.

The conveying pipe arrangement may comprise at least one conveying pipe part 20 of a pneumatic material conveying system. The conveying pipe part 20 of a pneumatic waste transport system may comprise an inner layer, i.e. a wear part 26, and an outer pipe part 25 that may have been arranged to enclose the wear part. According to one embodiment the outer pipe part 25 may be pressure-retaining plastic material. According to one embodiment the inner layer, i.e. the wear part 26, may be wear- and corrosion-resistant material, such as metal material. FIG. 5 shows the conveying pipe part 20 of one embodiment as a simplified view as seen from its end. The conveying pipe part has an outer diameter D1. The conveying pipe part has a diameter of the channel thereof, i.e. an inner diameter D2. According to one embodiment the conveying pipe part 20 may be cylindrical. For the purpose of clarity, the different parts of the conveying pipe parts in the figures may differ in their proportions from the proportions of the embodiments.

According to one embodiment, wall thickness s of the wear part 26 may be approximately 1-4 percent of the outer diameter D1 of the conveying pipe part 20. According to one embodiment, the wall thickness s of the wear part 26 may be approximately 1-2 percent of the outer diameter D1 of the conveying pipe part 20.

According to one embodiment, the wall thickness (s) of the wear part 26 may be approximately 2-8 mm. According to one embodiment, the thickness of the wall of the wear part may be approximately 3-5 mm. According to one embodiment, the outer diameter (D1) of the conveying pipe part 20 of the pneumatic material conveying system is approximately 250-550 mm.

According to one embodiment, the wear part 26 may comprise metal, steel or stainless steel. According to one embodiment, the wear part 26 may comprise wear-resistant material that may allow bending. Stainless or acid-resistant steel is typically corrosion-resistant and also wear-resistant, whereby it is well-suited for the wear part. It has also been discovered that when stainless steel is used as the wear part, the wall thickness s of the wear part may be reduced as compared to normal steel, because so-called corrosion allowance does not have to be considered in the wall thickness. Thereby the conveying pipe part provided with a thin wear part may be made relatively light in its mass. As a result, its handleability may be easy. In addition, the reduced wall thickness of the wear part of the pipe part may allow the pipe part to be bent more easily. The weight and easy bendability may have major significance as the pneumatic material conveying systems require, depending on the application, typically several kilometre long pipeworks.

According to one embodiment, the outer pipe part 25 may comprise pressure-retaining plastic material such as polyethylene (PE). According to one embodiment, the outer pipe part may comprise other suitable plastic material, the properties of which allow on the one hand the retaining of pressure and on the other hand the ability to form thermoplastic connections.

According to one embodiment, the conveying pipe part 20 may have been formed by heating the outer pipe part 25 and by bringing the wear part 26 into the channel space of the heated outer pipe part. Thereby an inner surface 32 of the wall of the outer pipe part 25 may be disposed against an outer surface 31 of the wall of the wear part 26. After cooling, the outer pipe part 25 may be pressed against the outer surface 31 of the wear part 25. According to one embodiment, the wear part 25 need not be a uniform pipe part, but it may have one or more slots or openings. According to one embodiment, the wear part 26 may comprise a slot, for example a longitudinal slot. This is possible also when it is used as a conveying pipe part of pneumatic material conveying systems, as the outer pipe part may have been arranged to retain the pressure, and therefore it does not matter in case the wear part should have opening(s) or slot(s).

According to one embodiment, the outer pipe part 25 may be polyethylene (PE) and the wear part 26 may be stainless steel. According to one embodiment, a plastic material-stainless steel-composite pipe part reinforced from the inner surface may thus be provided.

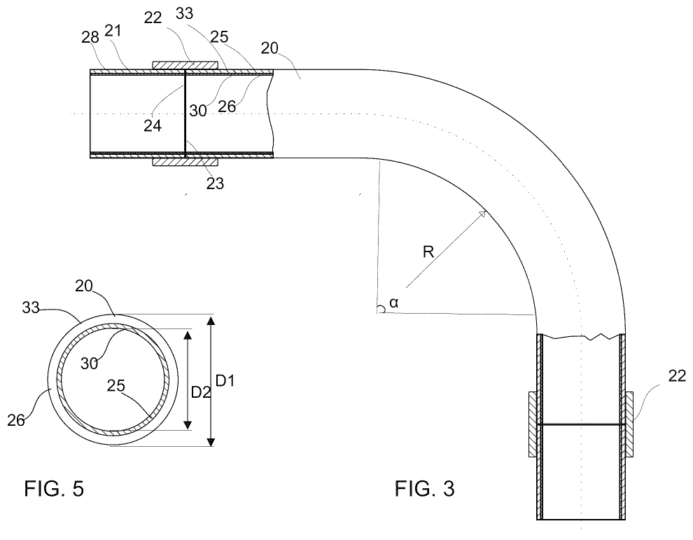

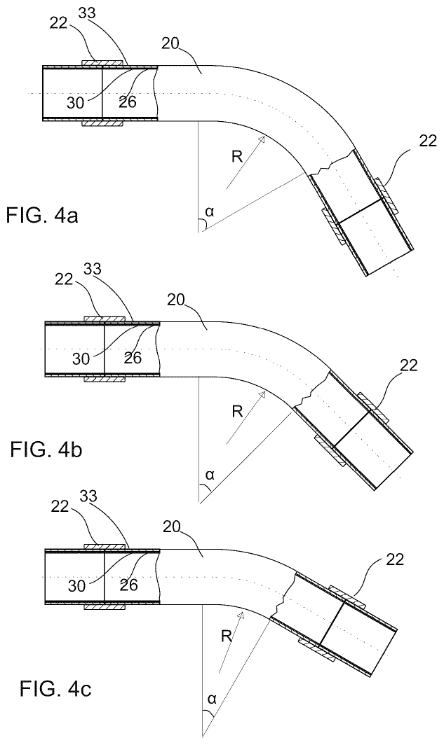

The conveying pipe part 20 may be a pipe part comprising a straight pipe section and/or a curved pipe section. FIGS. 1 and 2 illustrate straight conveying pipe parts in connection with the conveying pipe arrangement. FIGS. 3 and 4a, 4b, 4c illustrate conveying pipe arrangements that may comprise a curved conveying pipe part.

According to one embodiment, the conveying pipe part 20 may comprise a straight pipe section in proximity to each end area and/or a curved pipe section between the straight pipe sections. Curved conveying pipe sections may have been pre-formed for specific angular variations, or the conveying pipe part may be bent according to need. An angle alpha (a) may be provided between the inlet and outlet direction of the curved pipe section. The curved pipe section may have a bending radius (R). According to one embodiment, the angle alpha (a) between the inlet and outlet direction of the curved pipe section may be approximately 15-90 degrees. In the embodiment of FIG. 3 the angle alpha α of the curved pipe section may be approximately 90 degrees. In FIG. 4a the angle alpha α of the curved pipe section of the conveying pipe part 20 between the inlet and outlet directions is approximately 60 degrees. In FIG. 4b the angle alpha α between the inlet direction and the outlet direction of the curved pipe section of the conveying pipe part 20 is approximately 45 degrees. In FIG. 4c the angle alpha α between the inlet direction and the outlet direction of the curved pipe section of the conveying pipe part 20 is approximately 30 degrees. According to one embodiment, the bending radius of the curved pipe section may be approximately 2,5D-10D. According to one embodiment, D may be the diameter of the pipe, such as the outer diameter D1 or nominal diameter. According to one embodiment, the bending radius R of the curved pipe section may be approximately 1000-5500 mm. According to one embodiment, the bending radius R may be approximately 1500-2000 mm, most suitably 1700-1800 mm. According to one embodiment, the radius of curvature may be 1775 mm. According to one embodiment, the outer diameter D1 of the pipe may be approximately 250-550 mm. FIG. 3, 4a, 4b, 4c illustrate conveying pipe parts 20 having different angles of curvature a.

According to one embodiment, the conveying pipe arrangement of a pneumatic material conveying system may comprise a first conveying pipe part 20 and/or a second conveying pipe part 21. The conveying pipe parts 20, 21 may have been connected to each other by means of connection muffs, i.e. connection sleeve parts 22. According to one embodiment, the first conveying pipe part and/or the second conveying pipe part of the conveying pipe arrangement may be any of the above-described conveying pipe parts 20.

The first conveying pipe part 20 may comprise an outer pipe part 25 and a wear part 26. The first conveying pipe part 20 may comprise a wear part 26 and an outer pipe part 25 formed or arranged over the wear part, i.e. around the wear part. According to one embodiment, the outer pipe part 25 may be plastic material.

According to one embodiment, at a connection between the first conveying pipe part 20 and/or the second conveying pipe part 21, a connection sleeve part 22 may have been arranged to be used, which connection sleeve part may have been arranged to enclose a connection area of the first conveying pipe part 20 and/or the second conveying pipe part 21 disposed within the connection sleeve part 22.

According to one embodiment, the connection sleeve part 22 has been configured as a welding sleeve, comprising heating means, such as a resistance 43.

According to one embodiment, the first conveying pipe part 20 and/or the second conveying pipe part 21 may be a composite-steel pipe or a composite pipe.

One embodiment relates to a method for forming a conveying pipe arrangement of a pneumatic material conveying system. The conveying pipe arrangement may comprise at least one first conveying pipe part 20 and one second conveying pipe part 21, as well as a connection sleeve part 22. In the method, the first conveying pipe part 21 may be connected to the second conveying pipe part by inserting the ends of the first conveying pipe part 20 and the second conveying pipe part 21 to be connected to each other into the connection sleeve part 22, and by forming a thermoplastic connection with the at least one first conveying pipe part 20 and/or second conveying pipe part 21 and the connection sleeve part 22.

According to one embodiment, at least one of the conveying pipe parts 20, 21 may be formed by arranging a plastic material pipe forming an outer pipe part 26, 28 over a wear part 25, 27, or wherein the wear part 25, 26 is arranged in the channel space of the outer pipe part 26, 28, first by heating the outer pipe part 26, 28 and by bringing the wear part 25, 27 into the channel space of the outer pipe part, so as to form a conveying pipe part wherein the inner surface is the inner surface 30 of the wear part and the outer surface is the outer surface 33 of the outer pipe part 26, 28.

The second conveying pipe part 21 may comprise a wear part 28 and an outer pipe part 27, i.e. a plastic material part, formed or arranged over the wear part, i.e. around the wear part. The conveying pipe part may be formed for example by warming up the tubular outer pipe part 25, 27 plastic material part and by placing the tubular wear part 26, 28 in the channel space of the outer pipe part. When the tubular plastic material part 25, 27 cools, it may set around the tubular wear part against the wear part. The inner surface 32 of the outer pipe part thereby comes against the outer surface 31 of the wear part. The surface of the channel of the conveying pipe part is thereby formed by the inner surface 30 of the wear part.

The purpose of the wear part may be to in-crease wear resistance of the conveying pipe part against internal wearing. In the embodiment according to FIG. 1, in the first conveying pipe part 20 the wear part 26 may be the pipe part forming the inner surface 30 of the first pipe part 20. Over, i.e. around, the outer surface 31 of the wear part 26 there is an outer pipe part, i.e. a plastic material part, the outer surface 33 of which forms the outer surface of the first pipe part 20.

On the outer side of the wear part in the radial direction of the pipe there may have been provided an outer pipe part, i.e. a plastic material layer. The plastic material layer may have been formed to be pressure-retaining. In this case, the wear part may have been arranged to maintain the shape of the conveying pipe part and to facilitate the bending thereof. The plastic material layer may have been arranged to retain a desired underpressure or overpressure inside the conveying pipe part.

According to one embodiment, the wear part may be a pipe part. According to one embodiment, the wear part may comprise one or more openings or slots. According to one embodiment, the wear part may be mainly cylindrical, but may comprise a longitudinal slot. According to one embodiment, the wear part may have been formed from a sheet or strip by shaping, such as by bending to a mainly cylindrical shape. The wear part may thus have a slot or several slots, for example to facilitate bending, whereby the outer pipe part, i.e. the plastic material part, around the wear part may have been arranged to retain the pressure inside the conveying pipe part.

According to one embodiment, the wear part is metal.

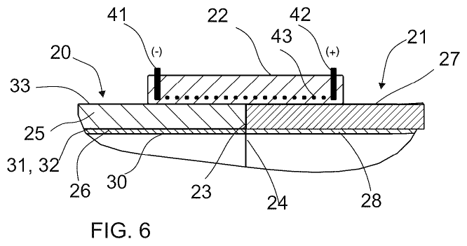

The connection sleeve part 22 may have heating means, such as thermal resistance wires, which warm up when electric current is supplied to them. The connection sleeve part 22 may have been provided with connection points 41, 42 known per se, which may have been coupled to the thermal resistance wire 43 (illustrated in FIG. 6) and which may be connected to electric current. The resistance wire 43 may have been arranged as a coil inside the connection sleeve part 22. As a result of heating of the resistance wire 43, a connection, such as a thermoplastic connection, may be formed in a manner known per se between the connection sleeve part 22 and the first conveying pipe part 20 and the second conveying pipe part 21. The connection may be formed by the outer pipe part 25 of the first pipe part 20 and the connection sleeve part, as well as by the outer pipe part of the second conveying pipe part 21 and the connection sleeve part. According to one embodiment, by the effect of heat a connection may also be formed between the outer pipe parts 25, 27 of the first and the second pipe parts 20, 21.

In the conveying pipe arrangement according to the figures, at the connection the first conveying pipe part 20 and the second pipe part 21 may have been connected to each other end to end. According to the embodiment of FIG. 1, the inner surface of the first conveying pipe part 20 and the inner surface of the second conveying pipe part 21 may be substantially aligned, so that no step hindering the conveying of material would be formed at the connection point 23, 24. The outer surfaces of the first conveying pipe part 20 and the second conveying pipe part 21 may be substantially aligned in the connection area, so that a connection can be formed between the connection sleeve part 22 and the plastic material of the outer pipe part 26 of the first pipe part 20 and the plastic material of the outer pipe part 28 of the second pipe part 21. The conveying pipe parts may be connected to each other by so-called electric welding. By warming the electrical resistances inside the parts or in the sleeve part the connection is formed between the pipe parts and the sleeve.

According to one embodiment, the connection may be formed by means of connecting the plastic material layers of the conveying pipe parts 20, 21 either directly by plastic welding or by plastic welding to the connection sleeve part 22 or by gluing.

According to one embodiment, the wall thickness of the wear part relative to the outer diameter of the pipe part may be for example 1-2 percent of the outer diameter. According to one embodiment, with an outer diameter of the wear part of for example 300 mm-400 mm, the thickness of the wall of the wear part may be for example 3-4 mm. According to one embodiment, with an outer diameter of the pipe part of for example 355 mm, the wear part may be in its wall thickness for example 3-4 mm, for example 3.5 mm. The thickness of the wall of the wear part may be smaller than the thickness of the wall of the plastic material part. According to one embodiment, the wall thickness of the wear part is approximately less than ½ of the total thickness of the wall of the pipe part, preferably 1/20-¼ of the total thickness of the wall of the pipe part.

On the outer side of the wear part in the radial direction of the pipe there may thus be a plastic material layer formed to be pressure-retaining. In this case, the wear part may maintain the shape of the conveying pipe part and facilitate the bending thereof and the outer pipe part, such as the plastic material layer thereof, ma y retain a desired under-/overpressure inside the conveying pipe part.

The thickness of the wall of the conveying pipe part may be in one embodiment approximately 20-40 mm. The thickness of the wall of the conveying pipe part may be smaller or greater than this. The thickness of the wall of the conveying pipe part may vary according to application.

According to one embodiment, the plastic material part may be or comprise wear-resistant material. Thus it does not matter if the wear part should wear through at some point, because the plastic material part would ensure sufficient wear resistance. The mechanical shape strength the conveying pipe part is, however, retained.

According to one embodiment, the conveying pipe part may be bent, for example at or in proximity to the installation site. In the bending, a mandrel may be used in the flow channel of the pipe part in order to prevent buckling of the wall of the pipe part. According to one embodiment, the conveying pipe part does not buckle in the same way as a mere plastic pipe during bending. The wear part may prevent deformation of the conveying pipe part after the bending, for example return to the shape before the bending. According to one embodiment, the conveying pipe part may be bent between 15-90 degrees, according to one embodiment the curved pipe section of the conveying pipe part may have been bent to an angle alpha between approximately 15-90 degrees between the inlet direction and the outlet direction of the pipe section. According to one embodiment, the bending radius R may be approximately 2.5D-10D, wherein D may be the outer diameter or nominal diameter of the conveying pipe part. According to one embodiment, the bending radius may be approximately 1000-5500 mm, when the outer diameter of the conveying pipe part is approximately 250-550 mm. According to one embodiment, the bending radius may be 1700-1800 mm, for example 1775 mm. According to one embodiment, the above-mentioned measures and angular values alpha may be applied for example to pipe diameters of 200-550 mm, most suitably to pipe diameters of 300-400 mm.

The wear part may receive mechanical stress in the pipe.

The wear part may be, in its wall thickness, thinner than a steel pipe being used as a conveying pipe alone. According to one embodiment, the wall thickness of the wear part may be for example 2-8 mm. According to one embodiment, the strength of the wall of the plastic material pipe may be for example 10-30 mm.

According to one embodiment, the connection sleeve part 22 may have been configured as a welding sleeve, comprising heating means, such as a resistance 43.

According to one embodiment, the connection sleeve part 22 may comprise plastic material or metal or has been formed from plastic or metal.

According to one embodiment, the first conveying pipe part 20 and/or the second conveying pipe part 21 may be a composite-steel pipe or a composite pipe. According to one embodiment, the composite may be plastic material. According to one embodiment, the plastic material may be for example polyethylene, for example type PE100. According to one embodiment, the wear part may be a steel pipe, for example structural steel, for example type S235. According to one embodiment, the steel pipe may have been painted on the outside and on its inner surface. According to one embodiment, the wear part is stainless or acid-resistant steel, for example type AISI 304 or AISI 316.

According to one embodiment, at least one of the conveying pipe parts 20, 21 may be formed by arranging a plastic material pipe 25, 27 over a wear part 26, 28 or the wear pipe in the channel space of the outer pipe part (the plastic material pipe), by heating the outer pipe part 25, 27 and by moving the outer pipe part 25, 27 and/or the wear part 26, 28 relative to each other, so as to form a conveying pipe part wherein the inner surface may be the inner surface 30 of the wear part and the outer surface may be the outer surface 33 of the outer pipe part. According to one embodiment, the outer surface 31 of the wear part 26 (the inner pipe part) may be disposed against the inner surface 32 of the outer pipe part 25.

1. A conveying pipe part of a pneumatic material conveying system for conveying solid materials, the conveying pipe part comprising an inner layer, i.e. a wear part, and an outer pipe part arranged to enclose the wear part, characterized in that the outer pipe part is pressure-retaining plastic material and that the inner layer, i.e. the wear part, is wear-resistant metal material, whereby the outer pipe part has been configured to retain mainly the imperviousness of the pipe part and the inner layer, i.e. the wear part, has been configured to receive the wearing applied to the pipe part from the inner side thereof.

2. The conveying pipe part according to claim 1, wherein the wear part is corrosion-resistant material.

3. The conveying pipe part according to claim 1, wherein wall thickness of the wear part is approximately 1-4 percent of an outer diameter of the conveying pipe part.

4. The conveying pipe part according to claim 1, wherein the wall thickness of the wear part is approximately 2-8 mm, most suitably approximately 3-5 mm, when the outer diameter of the conveying pipe part is approximately 250-550 mm.

5. The conveying pipe part according to claim 1, wherein the wear part comprises metal, steel or stainless steel.

6. The conveying pipe part according to claim 1, wherein the outer pipe part comprises pressure-retaining plastic material such as polyethylene.

7. The conveying pipe part according to claim 1, wherein the conveying pipe part has been formed by heating the outer pipe part and by bringing the wear part into the channel space of the heated outer pipe part, whereby an inner surface of the wall of the outer pipe part is disposed against an outer surface of the wall of the wear part, and in a cooled state the outer pipe part is pressed against the outer surface of the wear part.

8. The conveying pipe part according to claim 1, wherein the outer pipe part is polyethylene and the wear part is stainless steel.

9. The conveying pipe part according to claim 1, wherein the conveying pipe part is a pipe part comprising a straight pipe section and/or a curved pipe section.

10. The conveying pipe part according to claim 1, wherein the conveying pipe part comprises a straight pipe section in proximity to each end area and a curved section between the straight pipe sections, whereby an angle alpha is provided between the inlet and outlet direction of the curved section and wherein the curved pipe section has a bending radius.

11. The conveying pipe part according to claim 10, wherein the angle alpha between the inlet and outlet direction of the curved pipe section is approximately 15-90 degrees.

12. The conveying pipe part according to claim 10, wherein the bending radius of the curved pipe section is approximately 2.5D-10D.

13. The conveying pipe part according to any of claim 10, wherein the bending radius of the curved pipe section is 1000-5500 mm, when the outer diameter of the conveying pipe part is approximately 250-550 mm.

14. A conveying pipe arrangement of a pneumatic material conveying system, the arrangement comprising a first conveying pipe part and a second conveying pipe part, which first and/or second conveying pipe part is a conveying pipe part according to claim 1.

15. The conveying pipe arrangement according to claim 14, wherein, at a connection between the first conveying pipe part and/or the second conveying pipe part, a connection sleeve part has been arranged to be used, which connection sleeve part has been arranged to enclose a connection area of the first conveying pipe part and/or the second conveying pipe part disposed within the connection sleeve part.

16. The conveying pipe arrangement according to claim 14, wherein the connection sleeve part has been configured as a welding sleeve, comprising heating means, such as a resistance.

17. The conveying pipe arrangement according to claim 14, wherein the first conveying pipe section and/or the second conveying pipe section is a composite-steel pipe or a composite pipe.

18. A method for forming a conveying pipe arrangement of a pneumatic material conveying system, the conveying pipe arrangement comprising at least one first conveying pipe part and one second conveying pipe part, as well as a connection sleeve part, in which method the first conveying pipe part is connected to the second conveying pipe part by inserting the ends of the conveying pipe parts to be connected to each other into the connection sleeve part, and a thermoplastic connection is formed with the at least one first conveying pipe part and/or second conveying pipe part and the connection sleeve part.

19. The method according claim 18, wherein at least one of the conveying pipe parts is formed by arranging a plastic material pipe part forming an outer pipe part over a wear part or wherein the wear part is arranged in the channel space of the outer pipe part, first by heating the outer pipe part and by bringing the wear part into the channel space of the outer pipe part, so as to form a conveying pipe part wherein the inner surface is the inner surface of the wear part and the outer surface is the outer surface of the outer pipe part.
